(19) United States
(12) Patent Application Publication
(10) Pub. No.: US 2025/0014544 A1
(43) Pub. Date: Jan. 9, 2025

(54) INPUT DEVICE, CONTROL METHOD OF THE SAME, AND NON-TRANSITORY COMPUTER-READABLE STORAGE MEDIUM

(71) Applicant: YAMAHA CORPORATION, Hamamatsu-shi (JP)

(72) Inventor: Yuji MIURA, Hamamatsu-shi (JP)

(21) Appl. No.: 18/895,869

(22) Filed: Sep. 25, 2024

Related U.S. Application Data
(63) Continuation of application No. PCT/JP2022/048240, filed on Dec. 27, 2022.

(30) Foreign Application Priority Data
Mar. 25, 2022 (JP) 2022-049447

(51) Int. Cl. G10H 1/00; G10H 1/34

(52) U.S. Cl. CPC G10H 1/0008; G10H 1/34; G10H 2220/116; G10H 2220/221

(57) ABSTRACT

An input device includes: an operation reception portion including a first group of operators and a second group of operators. In response to reception of a setting instruction, a setting process is executed to set a sound parameter for a setting target pair of operators among pairs of operators in the operation reception portion. Each of the pairs of operators includes a first operator in the first group and a second operator in the second group which are in a mutually symmetrical position relationship. The setting process includes: a first process of reflecting, for the setting target pair, the setting of the sound parameter for the first operator on the second operator; or a second process of replacing, for the setting target pair, the sound parameter that is set for the first operator and the sound parameter that is set for the second operator.

### CROSS-REFERENCE TO RELATED APPLICATIONS

This is a continuation of International Application No. PCT/JP2022/048240 filed on Dec. 27, 2022, and claims priority from Japanese Patent Application No. 2022-049447 filed on Mar. 25, 2022, the entire content of which is incorporated herein by reference.

### FIELD

The present disclosure relates to an input device, a control method of the same, and a non-transitory computer-readable storage medium.

### BACKGROUND

JP2018-072734A discloses an input device that sets a sound parameter for a plurality of operators, and a sound parameter is assigned to each of operators (pads) for inputting performance information.

### SUMMARY

However, JP2018-072734A does not disclose how to set the sound parameter. A user may want to set a desired sound parameter to a desired operator. An operation of setting the sound parameter one by one for each operator is complicated. In addition, it may be desirable to use the same device for both right-handed and left-handed users. Therefore, it is desirable that a sound parameter setting operation can be efficiently performed.

An object of the present disclosure is to provide an input device capable of facilitating a sound parameter setting operation.

An aspect of the present disclosure provides an input device including: an operation reception portion including a first group including a plurality of operators and a second group including a plurality of operators disposed at symmetrical positions with the plurality of operators included in the first group, respectively; an instruction reception portion configured to receive a setting instruction on a setting of a sound parameter; a memory storing computer-executable instructions; and a processor that implements the computer-executable instructions stored in the memory to execute, in response to reception of the setting instruction, a setting process of setting the sound parameter for each of at least one setting target pair of operators, the at least one setting target pair of operators being a setting target among pairs of operators in the operation reception portion, each of the pairs of operators including a first operator among the plurality of operators in the first group and a second operator among the plurality of operators in the second group, the first operator and the second operator being in a mutually symmetrical position relationship, in which the setting process includes: a first process of reflecting, for each of the at least one setting target pair of operators, the setting of the sound parameter for the first operator of the first group also on the second operator of the second group; or a second process of replacing, for each of the at least one setting target pair of operators, the sound parameter that is set for the first operator of the first group and the sound parameter that is set for the second operator of the second group.

According to an aspect of the present disclosure, it is possible to facilitate a sound parameter setting operation.

### BRIEF DESCRIPTION OF DRAWINGS

The present disclosure will be described in detail based on the following without being limited thereto, wherein:

FIG. 1 is a plan view of an input device according to a first embodiment;

FIG. 2 is a plan view of a pad operation portion;

FIG. 3 is a plan view of the pad operation portion;

FIG. 4 is a block diagram of an input device;

FIG. 5 is a diagram showing a display example of a display portion when setting a “pair available for a setting target”;

FIG. 6 is a diagram showing a functional block for implementing a sound parameter setting process;

FIG. 7 is a flowchart showing the sound parameter setting process;

FIG. 8 is a plan view of a pad operation portion according to a modification; and

FIG. 9 is a perspective view of an input device according to a second embodiment.

### DETAILED DESCRIPTION

Hereinafter, embodiments of the present disclosure will be described with reference to the drawings.

### First Embodiment

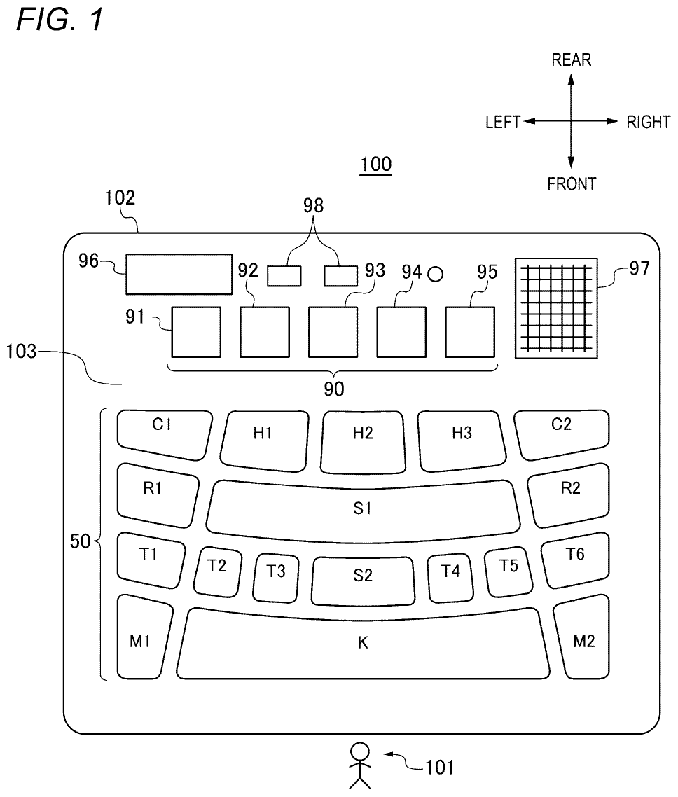

FIG. 1 is a plan view of an input device according to a first embodiment of the present disclosure. An input device 100 is an input device suitable for inputting a performance operation, and is implemented as an electronic musical instrument (electronic percussion instrument) as an example. The input device 100 is a device for setting or inputting a sound parameter.

The input device 100 includes a housing 102. A panel 103 is provided on an upper surface of the housing 102. A pad operation portion 50, a setting operation portion 90, a display portion 96, and a speaker 97 are disposed on the panel 103. The setting operation portion 90 is an instruction reception portion including an operator that receives a sound parameter setting instruction (or an input instruction) from a user 101. The setting operation portion 90 includes a menu button 91, a linkage mode validation/invalidation button 92 (designation portion), a replacement mode validation/invalidation button 93 (designation portion), a replacement execution button 94, a determination button 95, and increase and decrease buttons 98.

The pad operation portion 50 is an operation reception portion including a plurality of operators (hereinafter, referred to as pads) for the user 101 to input performance information. The plurality of pads included in the pad operation portion 50 include pads K, H1 to H3, C1, C2, S1, S2, R1, R2, M1, M2, and T1 to T6.

The user 101 usually uses the input device 100 at a position on a front side of the pad K, as shown in FIG. 1. Hereinafter, for the sake of convenience, the front side as viewed from the user 101 is defined as a front side, a back side is defined as a rear side, and a left-right direction is also based on the direction seen from the user 101.

Although each pad has a different shape, a basic configuration is common to one another. Each pad is a physical switch constituting an input area to be subjected to an input operation (performance operation). Each pad includes a surface sheet, a base plate (not shown), and a sensor (not shown). The base plate is, for example, a metal plate or a plastic plate. The sensor is disposed on the base plate, and the surface sheet is disposed thereon. The surface sheet constitutes a surface of the pad. The surface of the pad is flat and exposed from the panel 103. When performing the input operation, the user 101 may tap the pad with a finger. In order to alleviate an impact on the finger, for example, a rubber plate is employed as the surface sheet.

The sensor detects the input operation by the user 101. The sensor is provided for each pad. The sensor is, for example, a pressure sensor that detects a change in pressure applied to a corresponding pad. The sensor outputs a signal having an amplitude corresponding to a change in pressure as information indicating the input operation. The sensor is not limited to the pressure sensor, and may be a vibration sensor.

As an example, each pad is implemented as follows. A conductive pattern on a substrate, a conductive sheet, and a rubber sheet are disposed in order from the bottom. A spacer is provided under the conductive sheet, and even when the rubber sheet is placed on the conductive pattern, the conductive pattern and the conductive sheet are not electrically conductive, or are only slightly electrically conductive. When a pressure is applied from above by tapping (or pushing) the rubber sheet with a finger or the like, the conductive sheet is pushed and comes into contact with the conductive pattern, and a voltage value changes according to a contact area. When the sensor detects the voltage value, it is possible to detect a strength of tapping (or pushing) with a finger.

Each pad is assigned an electronic sound tone, such as a drum (which may also include percussion) tone. The tone of the electronic sound that can be assigned is not limited. When the user 101 performs the input operation on the pad, a sound of a tone corresponding to the pad is emitted from the speaker 97. As described later, the tone assigned to each pad can be changed. The tones assigned to certain pads may remain unchanged (fixed).

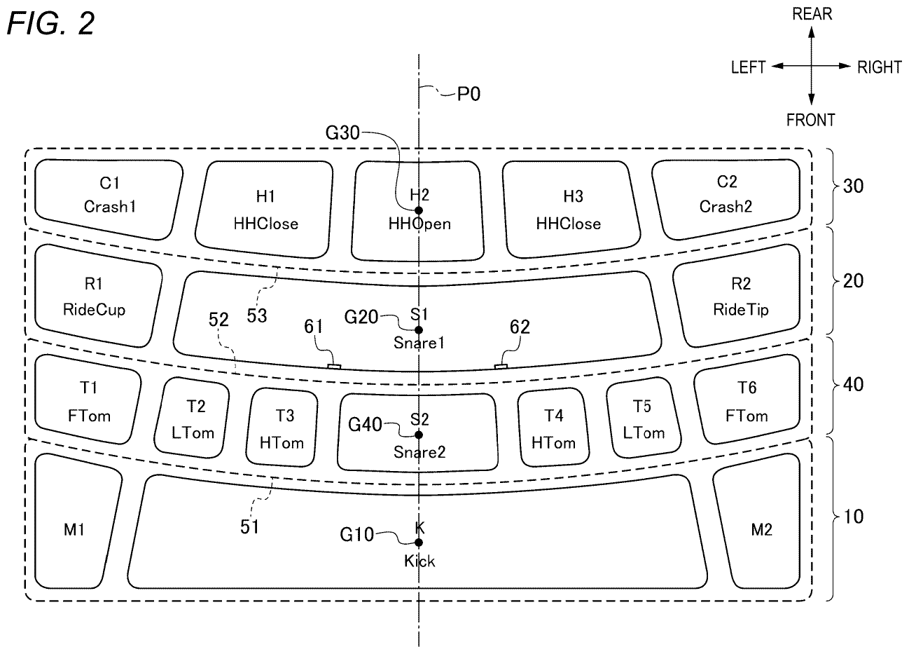

FIG. 2 is a plan view of the pad operation portion 50.

As shown in FIG. 2, the pad operation portion 50 includes a first region 10, a second region 20, a third region 30, and a fourth region 40. An arrangement direction of the first, second, third, and fourth regions is a front-rear direction. A direction orthogonal to the arrangement direction is a left-right direction. The first region 10, the fourth region 40, the second region 20, and the third region 30 are disposed in this order in a direction away from the first region 10 (rearward). The fourth region 40 is between the first region 10 and the third region 30. Shapes of the first region 10, the second region 20, and the third region 30 are different from one another. The first region 10 and the second region 20 are adjacent to each other in the front-rear direction.

The first region 10 mainly includes one or more pads to which a bass drum tone is assigned, and includes pads K, M1, and M2 as an example. The second region 20 mainly includes one or more pads to which a snare drum tone is assigned, and includes pads S1, R1, and R2 as an example. The third region 30 mainly includes one or more pads to which a cymbal tone is assigned, and includes pads H1 to H3, C1, and C2 as an example. The fourth region 40 mainly includes one or more pads to which a Tom tone is assigned, and includes pads S2 and T1 to T6 as an example.

The centroids of the pads K, S2, S1, and H2 are defined as G10, G40, G20, and G30, respectively. When viewed from above, a virtual straight line passing through G10, G40, G20, and G30 is defined as P0. The virtual straight line P0 is also a center line of the pad operation portion 50 extending in the left-right direction. The virtual straight line P0 is also a center line of each of the first region 10, the second region 20, the third region 30, and the fourth region 40 in the left-right direction. The input device 100 is assumed to be operated by either a right-handed dominant hand or a left-handed dominant hand, and is also assumed to be operated by both hands. Therefore, the entire pad is laid out line-symmetrically with respect to the virtual straight line P0 in the left-right direction.

First, the pads K, S2, S1, and H2 are disposed at the center in the left-right direction. The pads T1, T2, and T3 and the pads T6, T5, and T4 are respectively line-symmetrical with respect to the virtual straight line P0 (centered on the virtual straight line P0). The pads M1, R1, and C1 and the pads M2, R2, and C2 are respectively line-symmetrical with respect to the virtual straight line P0. The pads H1 and H3 are line-symmetrical with respect to the virtual straight line P0.

When viewed from above, a boundary line 51 between the first region 10 and the fourth region 40, a boundary line 53 between the second region 20 and the third region 30, and a boundary line 52 between the fourth region 40 and the second region 20 are all curved lines that are convex toward the front side. When viewed from above, opposing end surfaces of the pads that are adjacent to each other in the left-right direction are straight lines, and are inclined such that the farther back the end surfaces are, the closer the end surfaces are to the virtual straight line P0. Due to the inclination of the end surfaces and the curvature of the boundary lines, a performance input in a reasonable natural posture is facilitated.

The pad S1 is provided with convex portions 61 and 62 protruding upward. The user can visually recognize the position of the pad S1 by touching either of the convex portions 61 and 62.

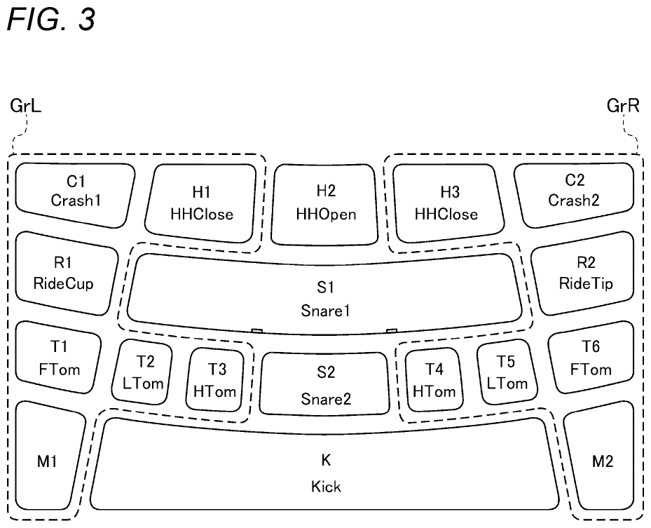

FIG. 3 is a plan view of the pad operation portion 50. A pair of operators (pads) having a mutually symmetrical position relationship is simply referred to as a “pair”. A left pad group is a first group GrL, and a right pad group is a second group GrR. The first group GrL includes the pads T1, T2, T3, M1, R1, C1, and H1. The second group GrR includes the pads T6, T5, T4, M2, R2, C2, and H3.

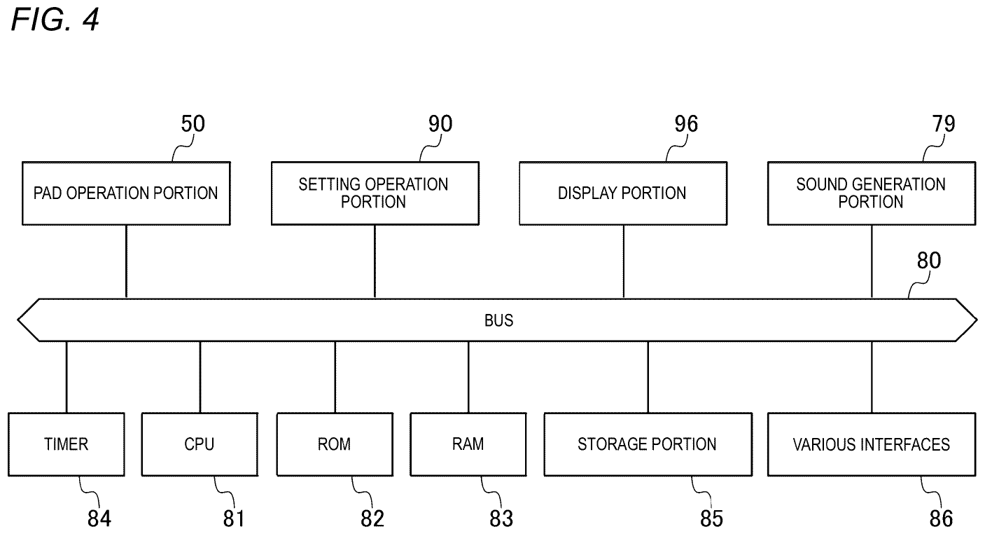

FIG. 4 is a block diagram of the input device 100. The performance information generated by operating each pad in the pad operation portion 50 and operation information generated by operating each operator in the setting operation portion 90 are sent to a CPU 81 via a bus 80. The display portion 96 includes an LCD or the like, and displays various kinds of information according to an instruction from the CPU 81. In addition, a sound generation portion 79, a ROM 82, a RAM 83, a timer 84, a storage portion 85, and various I/Fs (interfaces) 86 are connected to the CPU 81 via the bus 80.

The CPU 81 controls the entire device. The ROM 82 stores a control program executed by the CPU 81 and various kinds of data. The RAM 83 provides a work area when the CPU 81 executes the control program. The storage portion 85 includes a nonvolatile memory and stores various kinds of information. The various I/Fs 86 may include not only a wired or wireless communication I/F but also a musical instrument digital interface (MIDI). The sound generation portion 79 includes a sound source circuit and an effect circuit (not shown) in addition to the speaker 97 (FIG. 1), and generates a sound based on the performance information generated by operating the pad.

In the embodiment, setting modes of the sound parameter include a “linkage mode” and a “replacement mode”. These setting modes are applied to a pair of pads having a mutually symmetrical position relationship. A pair to which the setting mode is applied is referred to as a “setting target pair”.

The linkage mode is a mode of executing a linkage process (first process) in which, for the setting target pair, a setting of a sound parameter for the pads of the first group GrL (or the second group GrR) is also reflected on the pads of the second group GrR (or the first group GrL) which are disposed at symmetrical positions with the pads. The replacement mode is a mode of executing a replacement process (second process) in which, for the setting target pair, a sound parameter that is set for the pads of the first group GrL is replaced with a sound parameter that is set for the pads of the second group GrR which are disposed at symmetrical positions with the pads.

These two setting modes are not exclusively set, but can be individually set to be valid/invalid, and can coexist. The validation/invalidation of the linkage mode can be designated by a user operation on the linkage mode validation/invalidation button 92, and the validation/invalidation of the replacement mode can be designated by a user operation on the replacement mode validation/invalidation button 93.

In the linkage mode, the user can issue an instruction to execute the linkage process by pressing the determination button 95 in a state in which a sound parameter candidate to be set is input. For example, when the pad H1 and the pad H3 are the setting target pair and the linkage mode is valid, if a first sound parameter is assigned to the pad H1, the first sound parameter is also automatically assigned to the pad H3. The opposite is also true.

Meanwhile, it is assumed that the pad C1 and the pad C2 are the setting target pair and the replacement mode is valid. When an instruction to execute replacement is issued in a state in which the first sound parameter is assigned to the pad C1 and the second sound parameter is assigned to the pad C2, the second sound parameter is assigned to the pad C1 and the first sound parameter is assigned to the pad C2. That is, the assigned sound parameters are replaced between the pads C1 and C2.

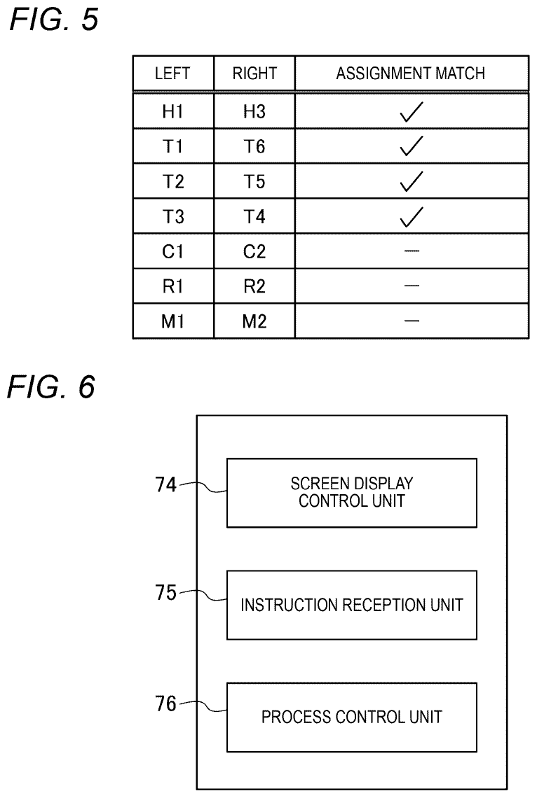

FIG. 5 is a diagram showing a display example of the display portion 96 when setting a “pair available for a setting target”. The pair available for the setting target is set by a user operation on the menu button 91, the increase and decrease buttons 98, the determination button 95, and the like. The user can set a pair available for the setting target by marking “assignment match”. For example, in the example of FIG. 5, the pads H1 and H3, the pads T1 and T6, the pads T2 and T5, and the pads C1 and C2 are set as the pairs available for the setting targets. The “pair available for the setting target” may be set individually in the linkage mode and the replacement mode.

A setting method of the pair available for the setting target is not limited to this method, and it is not essential to use a screen display. In addition, regardless of the user operation, all pads or certain pads may be treated as the pair available for the setting target.

In the linkage mode, a linkage direction may be one direction rather than both directions. For example, in the case of one direction, when the first sound parameter is assigned to the pad H1, the first sound parameter is automatically assigned to the pad H3, however, even if the second sound parameter is assigned to the pad H3, the sound parameter assigned to the pad H1 is not changed. Whether the linkage direction is both directions or one direction may be determined in advance or may be set by the user operation. In the linkage mode, pairs including pads for which different sound parameters are set at a time point before reception of a setting instruction may be excluded from the setting target pair.

In the replacement mode, all the pairs available for the setting target are the setting target pairs. On the other hand, in the linkage mode, among the pairs available for the setting target, a pair of a last struck (tapped) pad and a pad that has a symmetrical with the last struck pad is the setting target pair. A method for determining the setting target pair in the linkage mode is not limited to the present example. That is, another method may be employed as long as a state in which one pad is selected from a plurality of pads can be implemented. For example, the user may tap a desired pad with a strength equal to or greater than a threshold value, or the user may select a desired pad using a UI.

The linkage process in the linkage mode is executed, for example, when the user executes an operation to set the sound parameter (including a setting change). That is, in the linkage mode, when a sound parameter setting instruction for any one of the pads of the setting target pair is received as the setting instruction, the linkage process is executed as a setting process. The sound parameter setting instruction is received by the user operation on the menu button 91, the increase and decrease buttons 98, the determination button 95, and the like.

In the replacement mode, when an instruction to replace the sound parameter is received as the setting instruction, the replacement process is executed as the setting process. For example, when the replacement execution button 94 is pressed, the instruction to replace the sound parameter is received.

The number of sound parameters that can be set at a time for one pad is one or more, and two or more sound parameters can be collectively set. For example, the sound parameters mainly include “category”, “number”, “volume”, “pan”, “tuning”, “decay”, “cutoff”, “resonance”, “reverb send”, and “chorus send”, which are dependent on the tone (voice). In addition, the sound parameters mainly include “choke”, “link”, “velocity limit low”, “velocity limit high”, and “note repeat”, which are not dependent on the tone (pad). In addition, the sound parameters mainly include MIDI and pad performance (trigger), such as “MIDI channel”, “MIDI note number”, “velocity curve”, “velocity fixed value”, “velocity minimum”, “velocity maximum”, “after touch curve”, “after touch fixed value”, “after touch minim”, and “after touch maximum”.

FIG. 6 is a diagram showing a functional block for implementing the sound parameter setting process. The functional block includes a screen display control unit 74, an instruction reception unit 75, and a process control unit 76. Each function of the screen display control unit 74, the instruction reception unit 75, and the process control unit 76 is implemented by cooperation of the CPU 81, the ROM 82, the RAM 83, the timer 84, the storage portion 85, and the like. In the embodiment, the screen display control unit 74 is not essential, and the screen display control unit 74 is described in a second embodiment.

The instruction reception unit 75 receives a setting instruction to set the sound parameter. For example, the instruction reception unit 75 receives, as the setting instruction, the user operation on the menu button 91, the increase and decrease buttons 98, the determination button 95, and the like. In response to the reception of the setting instruction, the process control unit 76 executes the setting process of setting the sound parameter for the setting target pair. The process control unit 76 executes the linkage process (first process) in the linkage mode, and executes the replacement process (second process) in the replacement mode.

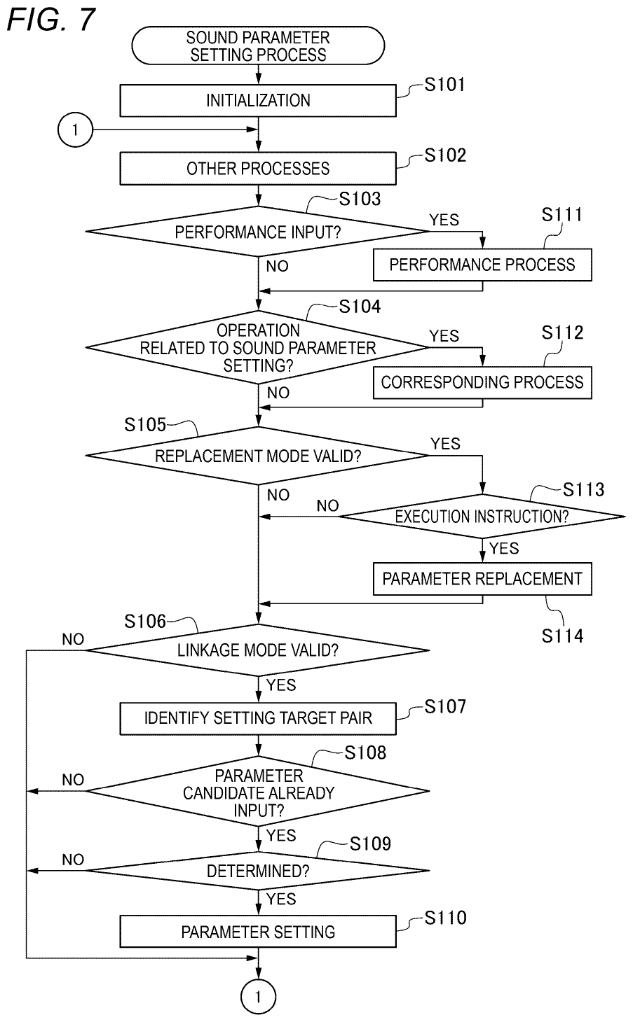

FIG. 7 is a flowchart showing the sound parameter setting process. The process is implemented by the CPU 81 loading and executing the program stored in the ROM 82 into the RAM 83. The process is started when a main power supply of the input device 100 is turned on. Alternatively, the process may be started when an instruction to start setting the sound parameter is received by the setting operation portion 90.

In step S101, the CPU 81 performs initialization. For example, the CPU 81 sets a setting of the sound parameter for each pad to a previous setting state. In addition, the CPU 81 sets the setting mode of the sound parameter to a default setting, and, for example, makes both the linkage mode and the replacement mode valid.

In step S102, the CPU 81 executes other processes. For example, the CPU 81 executes processes such as ending the sound parameter setting process in response to a user operation or an elapse of a predetermined time. Alternatively, the CPU 81 may execute an assignment process for the pads alone, which does not correspond to the linkage process or the replacement process.

In step S103, the CPU 81 determines whether there is a strike on the pad, that is, a performance input. Further, when there is a performance input, the CPU 81 executes a performance process based on the sound parameter assigned to a struck pad in step S111. For example, when the pad S1 to which a snare drum tone is assigned is struck, the CPU 81 causes the sound generation portion 79 to generate a sound that is a snare drum tone and corresponds to the set values of volume, pan, and the like.

When there is no performance input at step S103, the CPU 81 proceeds to step S104, and proceeds to step S104 after step S111. In step S104, the CPU 81 determines whether an operation related to a sound parameter setting is performed. The operation here includes an operation of setting the setting mode (the linkage mode or the replacement mode) and an operation of setting the pair available for the setting target, but does not include the sound parameter setting instruction. In addition, an input operation or the like of a sound parameter candidate to be set in the linkage mode is also included. The user can change the sound parameter candidate to be set at any time by operating the setting operation portion 90.

When there is an operation related to sound parameter setting, the CPU 81 executes a process corresponding to the operation in step S112, and proceeds to step S105. When there is no operation related to sound parameter setting, the CPU 81 proceeds to step S105.

In step S105, the CPU 81 determines whether the replacement mode is set to “valid”. The CPU 81 proceeds to step S106 when the replacement mode is not set to “valid”, and proceeds to step S113 when the replacement mode is set to “valid”.

In step S113, the CPU 81 determines whether there is an execution instruction (setting instruction) of the replacement process. As described above, when the replacement execution button 94 is pressed, it is determined that there is an execution instruction for the replacement process. The CPU 81 proceeds to step S106 when there is no execution instruction for the replacement process, and proceeds to step S114 when there is an execution instruction for the replacement process. When the replacement mode is temporarily set to “invalid”, even if the replacement execution button 94 is pressed, the action is not received as the execution instruction for the replacement process.

Since the input device 100 is assumed to be operated by any dominant hand, it can be considered that the replacement process is substantially switched between a right-handed use and a left-handed use. From this point of view, the execution instruction for the replacement process may be interpreted as a switching execution instruction of the dominant hand.

In step S114, the CPU 81 executes the replacement process. That is, the CPU 81 replaces the set sound parameter between the pads of the first group GrL and the pads of the second group GrR in each of the setting target pairs. For example, when first and second crash cymbal tones are assigned to the pads C1 and C2, respectively, the second crash cymbal tone is assigned to the pad C1 and the first crash cymbal tone is assigned to the pad C2 by the replacement process. Alternatively, if the pair available for the setting target is in the setting state shown in FIG. 5, the assigned sound parameters are switched between the pads H1, T1, T2, and T3 among the first group GrL and the pads H3, T6, T5, and T4 among the second group GrR. The process of step S114 is valid, for example, for switching between “left-handed” and “right-handed”. After step S114, the CPU 81 proceeds to step S106.

In step S106, the CPU 81 determines whether the linkage mode is set to “valid”. Then, the CPU 81 returns to step S102 when the linkage mode is not set to “valid”, and proceeds to step S107 when the linkage mode is set to “valid”.

In step S107, the CPU 81 identifies a setting target pair. As described above, the CPU 81 identifies, as the setting target pair, a pair to which a pad struck last (immediately before) belongs among the pairs available for the setting target. When the last struck pad is not stored, such as when the pad is used for the first time, the CPU 81 may identify a default pad pair as the setting target pair. Normally, the user may tap any one of the pads in the pair to which the linkage process is applied for at least one time, and then may shift to the operation for the linkage process.

In step S108, the CPU 81 determines whether the sound parameter candidate to be set is already input. The candidate is input in step S112. Then, the CPU 81 returns to step S102 when the sound parameter candidate is not already input, and proceeds to step S109 when the sound parameter candidate is already input.

In step S109, the CPU 81 determines whether an operation (setting instruction) of determining the sound parameter to be set in the linkage mode is received. Here, it is determined whether the determination button 95 is pressed. Then, the CPU 81 returns to step S102 when the operation of determining the sound parameter to be set is not received, and proceeds to step S110 when the operation of determining the sound parameter to be set is received.

In step S110, the CPU 81 sets the sound parameter for the setting target pair by the linkage process. For example, if the determination button 95 is pressed in a state in which a candidate “maple floor tom” among tom tones is input to the pad T1, the “maple floor tom” is assigned to both the pads T1 and T6. The process is valid, for example, for maintaining an assignment state suitable for both “left-handed” and “right-handed”. Thereafter, the CPU 81 returns to step S102.

When it is set to exclude, from the setting target pair, a pair including pads for which different sound parameters are set, the process in step S107 is performed as follows. That is, when different sound parameters are set for the pads of the pair to which the last struck pad belongs, the CPU 81 determines that there is no setting target pair, and proceeds to step S108. Thereafter, when a transition is made in the order of S108 to S109 to S110, in step S110, the CPU 81 independently sets the sound parameter candidate for the last struck pad.

When the linkage direction is set as one direction, the process in step S107 is performed as follows. For example, a case in which one direction setting is performed in which the assignment in the first group GrL is also reflected in the second group GrR but the assignment in the second group GrR is not reflected in the first group GrL will be described as an example. When the last struck pad belongs to the first group GrL, the CPU 81 identifies the pair to which the last struck pad belongs as the setting target pair as usual.

However, when the last struck pad belongs to the second group GrR, in step S107, the CPU 81 determines that there is no setting target pair, and proceeds to step S108. Thereafter, when a transition is made in the order of S108 to S109 to S110, in step S110, the CPU 81 independently sets the sound parameter candidate for the last struck pad.

According to the embodiment, the pad operation portion 50 includes the first group GrL including a plurality of pads and the second group GrR including a plurality of pads disposed at symmetrical positions with the plurality of pads included in the first group GrL. At least one of the pairs of the pads (operators) having a mutually symmetrical position relationship is a setting target pair. In response to the reception of the sound parameter setting instruction, the CPU 81 serving as the control unit executes the setting process of setting the sound parameter for the setting target pair.

When the sound parameter setting instruction for any one of the pads of the setting target pair is received as the setting instruction, the CPU 81 performs the linkage process (first process) as the setting process. In the linkage process, the CPU 81 reflects, for the setting target pair, the setting of the sound parameter for the pads of the first group GrL (or the second group GrR) also on the pads of the second group GrR (or the first group GrL). When an instruction to replace the sound parameter is received as the setting instruction, the CPU 81 executes the replacement process (second process) as the setting process. In the replacement process, the CPU 81 replaces, for the setting target pair, the sound parameters that are set for the pads of the first group GrL and the sound parameters that are set for the pads of the second group GrR. By these processes, the sound parameter setting operation can be facilitated.

For example, a finger drummer can easily create a typical pad assignment. It is possible to easily use one input device 100 among a plurality of users having different dominant hands. Therefore, the finger drummer can obtain the same performance feeling regardless of the dominant hand. It is also possible to change the assignment of a plurality of pads by a simple operation.

In addition, by excluding, from the setting target pair, a pair including pads for which different sound parameters are set, it is possible to avoid a linkage setting of a pad that is considered to be not intended to be subjected to the linkage setting, and to improve usability.

In addition, it is possible to designate validation/invalidation of each of the linkage mode and the replacement mode. The setting target pair can be determined in accordance with the user operation. Further, in the linkage mode, it is possible to designate whether the linkage direction is both directions or one direction. Therefore, the usability can be improved.

In addition, since two or more sound parameters can be collectively set for one pad when the setting process is performed, a setting operation can be simplified.

In the embodiment, even in the linkage mode, a plurality of pairs may be designated as the setting target pair, and the assignment state may be aligned (unified or matched) with any of the first group GrL and the second group GrR. In this case, it is not necessary to input the sound parameter candidate, and step S108 may be eliminated. After step S107, the process is performed as follows.

For example, in step S107, the CPU 81 identifies, as the setting target pairs, all of the “pairs available for the setting targets” marked with the “assignment match” on the display screen shown in FIG. 5. Further, the CPU 81 identifies whether the group to which the last struck pad among the setting target pairs belongs (as used herein, the group is referred to as a preferential group) is the first group GrL or the second group GrR. Next, in step S109, when there is a setting instruction by pressing the determination button 95, in step S110, the CPU 81 reflects, for all the setting target pairs, the assignment state of each pad in the preferential group on the corresponding pad having a symmetrical position relationship with the each pad. That is, the CPU 81 sets an assignment setting of a sound parameter for a non-preferential group to the same state as the assignment setting of the sound parameter for the preferential group. The process is valid, for example, in setting an assignment state suitable for both “left-handed” and “right-handed”.

It is not essential to be able to designate whether the linkage mode or the replacement mode is valid/invalid, and both modes may be normally valid.

In addition, regarding the validation/invalidation of each mode, the following configuration may be used. First, the validation/invalidation of each mode may be set in units of pad. It may be possible to select whether to validate/invalidate each mode when executing the mode. Any mode may be normally valid. The linkage mode and the replacement mode may be exclusively valid. The validation/invalidation of each mode may be switched in conjunction with other settings. By referring to other settings (according to other settings), each mode may be switched between validation/invalidation. The validation/invalidation of each mode may be switched according to a type of changed sound parameter.

The setting state immediately before the execution of the setting process may be stored so as to be restored by a predetermined operation.

Each of the boundary lines 51, 53, and 52 is a curved line protruding toward the front side. However, this is not essential, and all of the boundary lines 51, 53, and 52 may be straight lines parallel to the left-right direction.

The present disclosure is applied to a device in which a plurality of pads included in the first group GrL and a plurality of pads included in the second group GrR are at symmetrical positions. Here, “symmetrical” is not limited to left-right symmetry and is not limited to line symmetry. Therefore, up-down symmetry and point symmetry are also included.

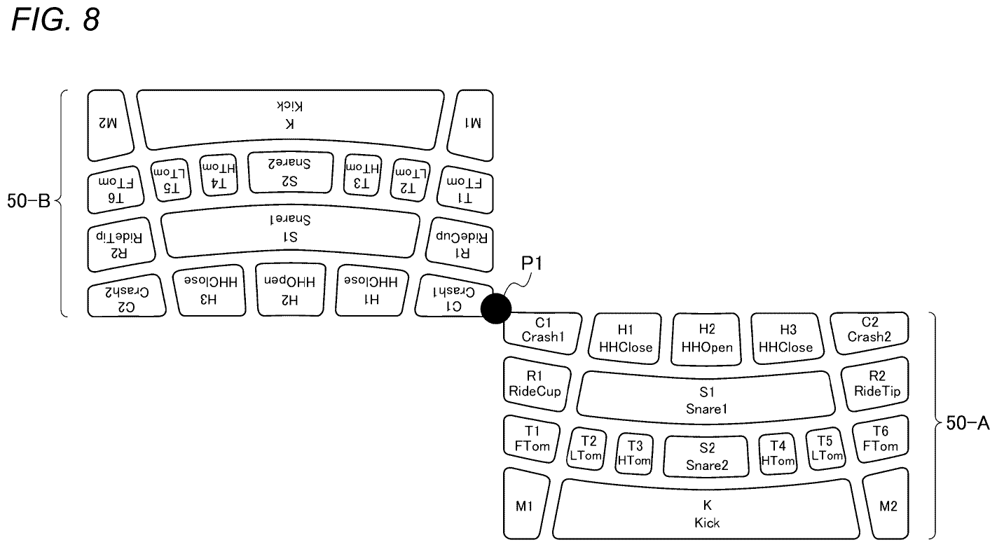

For example, as shown in a modification in FIG. 8, a device having point-symmetrical pads may be used. In the example shown in FIG. 8, in one housing, a first pad operation portion 50-A and a second pad operation portion 50-B having the same pad layout are point-symmetrically disposed with respect to the point P1.

The first pad operation portion 50-A corresponds to the first group GrL, and the second pad operation portion 50-B corresponds to the second group GrR. In the present example, all pads are pads that are in a point symmetry relationship with each other with respect to the point P1. Therefore, the pads K, S1, S2, and H2 of the first pad operation portion 50-A and the pads K, S1, S2, and H2 of the second pad operation portion 50-B are also in the point symmetry relationship.

### Second Embodiment

In the first embodiment, the pad is a physical switch. However, the present disclosure can be applied to a virtual pad.

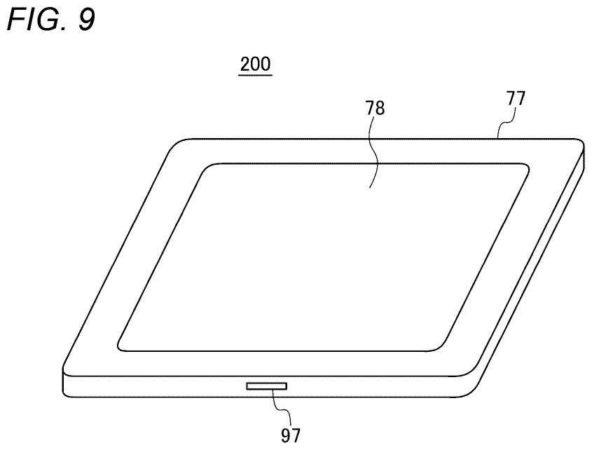

FIG. 9 is a perspective view of an input device according to a second embodiment of the present disclosure. An input device 200 includes a main body 77 and a screen portion 78. The input device 200 is obtained by adding the screen portion 78 to the elements shown in FIG. 4 excluding the pad operation portion 50 and the setting operation portion 90. The pad operation portion 50 and the setting operation portion 90 are implemented by being displayed on the screen portion 78. The setting operation portion 90 may be physically provided as in the first embodiment. Although the display portion 96 is not shown, the display portion 96 may also be implemented by the screen portion 78.

The screen display control unit 74 (FIG. 6) displays, on the screen portion 78 (on the screen), the first group GrL including a plurality of pads (operators) and the second group GrR including a plurality of pads disposed at symmetrical positions with the plurality of pads included in the first group GrL. That is, a pad group having a layout same as that shown in FIG. 3 is displayed on the screen portion 78 in a touch-operable manner. The process is executed, for example, in step S102 of FIG. 7. The processes after step S103 are the same as those described in the first embodiment.

According to the embodiment, it is possible to achieve the effect same as that of the first embodiment with regard to facilitating a sound parameter setting operation.

It is not essential to provide all of the first to fourth regions, and it is not essential to provide all of the illustrated pads.

The input device does not necessarily have to be implemented as an electronic musical instrument, and does not necessarily have a sound generation function. Therefore, it is not essential to provide the speaker 97. For example, an output terminal may be provided in the input device, and sound information corresponding to an input operation may be output from the output terminal to the outside. For example, a sound generation device (not shown) may be connected to the output terminal, and a sound may be generated from the sound generation device. The input device may be used to input performance information to be recorded by recording the input performance information in a memory (not shown) or outputting the input performance information to the outside. The input performance information may be reproduced or recorded in another device.

The physical pad operation portion 50 shown in the first embodiment and the virtual pad operation portion shown in the second embodiment may be provided on a panel surface or the like of an electronic musical instrument (electronic keyboard instrument or the like). The input device 100 may be mounted on another electronic device such as an electronic musical instrument (portable keyboard or the like) or a MIDI keyboard. Alternatively, in an electronic keyboard instrument, a keyboard itself may be used as the physical pad operation portion 50. For example, if the entire keyboard or a specific key range is defined as a center, at least white keys can be said to be left-right symmetrical, and thus the present disclosure can be applied thereto. In this case, the electronic musical instrument is the input device in the present disclosure.

Although the present disclosure has been described in detail based on a preferred embodiment thereof, the present disclosure is not limited to the specific embodiment, and various forms without departing from the scope of the present disclosure are also included in the present disclosure. Some of the above-described embodiments may be appropriately combined.

A storage medium storing a control program represented by software for achieving the present disclosure may be read into the input device to achieve the effects same as that of the present disclosure. In this case, a program code itself read from the storage medium achieves a novel function of the present disclosure, and a non-transitory computer-readable storage medium storing the program code constitutes the present disclosure. The program code may be supplied via a transmission medium or the like, in which case the program code itself constitutes the present disclosure. In addition to the ROM, a floppy disk, a hard disk, an optical disk, a magneto-optical disk, a CD-ROM, a CD-R, a magnetic tape, a non-volatile memory card, or the like may be used as the storage medium in such a case. The non-transitory computer-readable storage medium includes a medium that holds a program for a certain period of time, such as a volatile memory (for example, a dynamic random access memory (DRAM)) inside a computer system serving as a server or a client when a program is transmitted via a network such as the Internet or a communication line such as a telephone line.

1. An input device comprising:
an operation reception portion comprising a first group including a plurality of operators and a second group including a plurality of operators disposed at symmetrical positions with the plurality of operators included in the first group, respectively;
an instruction reception portion configured to receive a setting instruction on a setting of a sound parameter;
a memory storing computer-executable instructions; and
a processor that implements the computer-executable instructions stored in the memory to execute, in response to reception of the setting instruction, a setting process of setting the sound parameter for each of at least one setting target pair of operators, the at least one setting target pair of operators being a setting target among pairs of operators in the operation reception portion, each of the pairs of operators including a first operator among the plurality of operators in the first group and a second operator among the plurality of operators in the second group, the first operator and the second operator being in a mutually symmetrical position relationship,
wherein the setting process includes:
a first process of reflecting, for each of the at least one setting target pair of operators, the setting of the sound parameter for the first operator of the first group also on the second operator of the second group; or
a second process of replacing, for each of the at least one setting target pair of operators, the sound parameter that is set for the first operator of the first group and the sound parameter that is set for the second operator of the second group.

2. The input device according to claim 1, wherein in a case in which a setting instruction on a sound parameter for the first operator of the first group is received as the setting instruction, the first process is executed as the setting process.

3. The input device according to claim 2, wherein in a case in which a setting instruction on a sound parameter for the second operator of the second group is received, the setting of the sound parameter for the second operator of the second group is reflected on the target first operator of the first group.

4. The input device according to claim 2, wherein a pair of operators in which sound parameters that are set for the first operator and the second operator are different from each other at a time point before the reception of the setting instruction is excluded from the setting target pair of operators.

5. The input device according to claim 1, further comprising:
a designation portion configured to designate validation or invalidation of the first process,
wherein the first process is executed on condition that the first process is valid.

6. The input device according to claim 1, wherein the second process is executed as the setting process in a case in which an instruction to replace the sound parameter is received as the setting instruction.

7. The input device according to claim 6, further comprising:
a designation portion configured to designate validation or invalidation of the second process,
wherein the instruction reception portion receives the instruction to replace the sound parameter as the setting instruction only in a case in which the second process is valid.

8. The input device according to claim 1, wherein two or more sound parameters are allowed to be collectively set for one of the operators when executing the setting process.

9. The input device according to claim 1, wherein the setting target pair of operators is determined in advance.

10. The input device according to claim 1, wherein the setting target pair of operators is determined in accordance with a user operation.

11. The input device according to claim 1, wherein the symmetrical positions are a line-symmetrical positions.

12. The input device according to claim 1, wherein the sound parameter includes at least a voice.

13. A control method of an input device implemented by a computer, the input device comprising a first group including a plurality of operators and a second group including a plurality of operators disposed at symmetrical positions with the plurality of operators included in the first group, respectively, the control method comprising:
receiving a setting instruction on a setting of a sound parameter; and
executing, in response to reception of the setting instruction, a setting process of setting the sound parameter for each of at least one setting target pair of operators, the at least one setting target pair of operators being a setting target among pairs of operators, each of the pairs of operators including a first operator among the plurality of operators in the first group and a second operator among the plurality of operators in the second group, the first operator and the second operator being in a mutually symmetrical position relationship;
wherein the setting process includes:
a first process of reflecting, for each of the at least one setting target pair of operators, the setting of the sound parameter for the first operator of the first group also on the second operator of the second group; or
a second process of replacing, for each of the at least one setting target pair of operators, the sound parameter that is set for the first operator of the first group and the sound parameter that is set for the second operator of the second group.

14. A control method of an input device implemented by a computer, the input device comprising a first group including a plurality of operators and a second group including a plurality of operators disposed at symmetrical positions with the plurality of operators included in the first group, respectively, the control method comprising:
causing the first group the second group to be displayed on a screen;
receiving a setting instruction on a setting of a sound parameter; and
executing, in response to reception of the setting instruction, a setting process of setting the sound parameter for each of at least one setting target pair of operators, the at least one setting target pair of operators being a setting target among pairs of operators, each of the pairs of operators including a first operator among the plurality of operators in the first group and a second operator among the plurality of operators in the second group, the first operator and the second operator being in a mutually symmetrical position relationship;
wherein the setting process includes:
a first process of reflecting, for each of the at least one setting target pair of operators, the setting of the sound parameter for the first operator of the first group also on the second operator of the second group; or
a second process of replacing, for each of the at least one setting target pair of operators, the sound parameter that is set for the first operator of the first group and the sound parameter that is set for the second operator of the second group.

15. A non-transitory computer-readable storage medium storing a program executable by a computer to execute a control method of an input device, the input device comprising a first group including a plurality of operators and a second group including a plurality of operators disposed at symmetrical positions with the plurality of operators included in the first group, respectively, the control method comprising:
receiving a setting instruction on a setting of a sound parameter; and
executing, in response to reception of the setting instruction, a setting process of setting the sound parameter for each of at least one setting target pair of operators, the at least one setting target pair of operators being a setting target among pairs of operators, each of the pairs of operators including a first operator among the plurality of operators in the first group and a second operator among the plurality of operators in the second group, the first operator and the second operator being in a mutually symmetrical position relationship;
wherein the setting process includes:
a first process of reflecting, for each of the at least one setting target pair of operators, the setting of the sound parameter for the first operator of the first group also on the second operator of the second group; or
a second process of replacing, for each of the at least one setting target pair of operators, the sound parameter that is set for the first operator of the first group and the sound parameter that is set for the second operator of the second group.

16. A non-transitory computer-readable storage medium storing a program executable by a computer to execute a control method of an input device, the input device comprising a first group including a plurality of operators and a second group including a plurality of operators disposed at symmetrical positions with the plurality of operators included in the first group, respectively, the control method of the input device comprising:
causing the first group and the second group to be displayed on a screen;
receiving a setting instruction on a setting of a sound parameter; and
executing, in response to reception of the setting instruction, a setting process of setting the sound parameter for each of at least one setting target pair of operators, the at least one setting target pair of operators being a setting target among pairs of operators, each of the pairs of operators including a first operator among the plurality of operators in the first group and a second operator among the plurality of operators in the second group, the first operator and the second operator being in a mutually symmetrical position relationship;
wherein the setting process includes:
a first process of reflecting, for each of the at least one setting target pair of operators, the setting of the sound parameter for the first operator of the first group also on the second operator of the second group; or
a second process of replacing, for each of the at least one setting target pair of operators, the sound parameter that is set for the first operator of the first group and the sound parameter that is set for the second operator of the second group.
